(19) United States
(12) Patent Application Publication
(10) Pub. No.: US 2021/0142161 A1
(43) Pub. Date: May 13, 2021

(54) SYSTEMS AND METHODS FOR MODEL-BASED TIME SERIES ANALYSIS

(71) Applicant: General Electric Company, Schenectady, NY (US)

(72) Inventors: Hao Huang, San Ramon, CA (US); Abhinav Saxena, Milpitas, CA (US)

(21) Appl. No.: 16/683,007

(22) Filed: Nov. 13, 2019

(51) Int. Cl. G06N 3/08; G06F 16/2458; G06F 16/21; G06N 3/04

(52) U.S. Cl. CPC G06N 3/08; G06N 3/0445; G06F 16/212; G06F 16/2474

(57) ABSTRACT

A system for detecting an event is provided. The system includes a computing device including at least one processor in communication with at least one memory device. The at least one processor is programmed to execute a model for analyzing a time series of data, receive a labeled time series of data including a plurality of variables at a plurality of points in time, analyze the labeled time series of data, generate a causal graph of an event based on the analysis, calculate a predicted value for one or more variables of the plurality of variables at a specific point in time, compare the predicted value to an observed value for the one or more variables, and adjust the model based on the comparison.

### BACKGROUND

The field of the present disclosure relates generally to analyzing real-time data and, more specifically, to analyzing multivariate time series data and causal graphs in combination and in real-time.

Time series classification may be used for practical applications in many domains. Some practical examples include biomedicine, hospitals, hotels and transportation, industrial event detection in mechanical systems, identifying heartbeat patterns of patients in hospitals, and detecting stock market events. In addition, learning the causal graph of different types of time series is of great importance for knowledge discovery and decision-making. It is useful for Explainable Artificial Intelligence, because causal graphs may detect differences in various time series. In a causal graph, each node represents a variable or component of the targeted system, and the edges each describe the causality relationship between the two connected nodes. However, causal graph learning is an especially challenging task because of 1) the unknown and complex (usually nonlinear) relationship existing inside the system, 2) noise in the dataset, and 3) limited amount of data available on certain type of time series, i.e., uncommon failure. Furthermore, many current baselines that rely on either time series classification or causal learning graphs suffer from label imbalance. Accordingly, it would be useful to combine multivariate time series and causal graphs while addressing the label imbalance problem.

### BRIEF DESCRIPTION

In one aspect, a system is provided. The system includes a computing device including at least one processor in communication with at least one memory device. The at least one processor is programmed to execute a model for analyzing a time series of data, receive a labeled time series of data including a plurality of variables at a plurality of points in time, analyze the labeled time series of data, generate a causal graph of an event based on the analysis, calculate a predicted value for one or more variables of the plurality of variables at a specific point in time, compare the predicted value to an observed value for the one or more variables, and adjust the model based on the comparison.

In another embodiment, a system is provided. The system includes a computing device including at least one processor in communication with at least one memory device. The at least one processor is programmed to execute a model for analyzing a time series of data. The model includes a plurality of classes. The at least one processor is also programmed to receive an unlabeled time series of data including a plurality of variables at a plurality of points in time, analyze the unlabeled time series of data, compare the analyzed data to the plurality of classes, for each class of the plurality of classes, calculate a predicted value for one or more variables of the plurality of variables at a specific point in time, compare the plurality of predicted values to an observed value for the one or more variables, and assign a label to the time series of data based on the comparison.

In another embodiment, a method for detecting an event is provided. The method is implemented by a computing device including at least one processor in communication with at least one memory device. The method includes executing a model for analyzing a time series of data. The model includes a plurality of classes. The method also includes receiving an unlabeled time series of data including a plurality of variables at a plurality of points in time, analyzing the unlabeled time series of data, comparing the analyzed data to the plurality of classes, for each class, calculating a predicted value for one or more variables of the plurality of variables at a specific point in time, comparing the predicted value to an observed value for the one or more variables, and assigning a label to the time series of data based on the comparison

### BRIEF DESCRIPTION OF THE DRAWINGS

FIG. 1 illustrates a block diagram of a time series classification and causal graph learning (TCCL) model in accordance with one embodiment of the present disclosure.

FIG. 2 illustrates a block diagram of an exemplary gated recurrent unit used with the TCCL model shown in FIG. 1.

FIG. 3 is a flowchart illustrating an example process for training the TCCL model shown in FIG. 1.

FIG. 4 is a flowchart illustrating an example process for monitoring data using the TCCL model shown in FIG. 1.

FIG. 5 is a simplified block diagram of an example system for executing the TCCL model shown in FIG. 1 during the processes shown in FIGS. 3 and 4.

FIG. 6 illustrates an example configuration of a client computer device shown in FIG. 5, in accordance with one embodiment of the present disclosure.

FIG. 7 illustrates an example configuration of the server system shown in FIG. 5, in accordance with one embodiment of the present disclosure.

### DETAILED DESCRIPTION

The implementations described herein relate to systems and methods for analyzing real-time data and, more specifically, to analyzing multivariate time series data and causal graphs in combination and in real-time. More specifically, a time series classification and causal graph learning (TCCL) model is executed by a computing device to (1) identify the class of time series input data; (2) discover the causal graph of each time series class; and (3) compare the different learned causal graphs to identify differences and similarities between time series classes.

For the purposes of this disclosure time series data is denoted with m variables and length n as X={X(1, *), X(2, *), . . . , X(m, *)}∈ [symbol] ^{m×n}, where X(i, *)={X(i, t₁), X(i, t₂), . . . , X(i, tₙ)}∈ [symbol] ^{1×n} is the time series associated to the i-th variable. X(i, tⱼ) is the value of the i-th variable at time tⱼ where j=1, 2, . . . , n. And X(*, tⱼ)={X(1, tⱼ), X(2, tⱼ), . . . , X(m, tⱼ)}∈ [symbol] ^{m×1} indicates the values of all the m variables at time tⱼ.

Given K time series classes, a labeled time series dataset with N time series is noted as χ={(X₁, Y₁), (X₂, Y₂), . . . , (X_{N}, Y_{N})}, where Xᵢ∈ [symbol] ^{m×n} is a time series with m variables and length n, and Yᵢ∈ [symbol] ^{K×1} is the corresponding one hot label vector with Yi(k)=1 if Xᵢ belongs to the k-th class and the other values are 0. The ground truth of the k-th class's causal graph is denoted as A^{(k)}∈ [symbol] ^{m×m} with non-negative elements. The value of A^{(k)}(i, j) indicates the strength of causality from the i-th to the j-th variable.

Multivariate Granger causality analysis approaches causal graph through fitting a vector autoregressive model (VAR) to time series data. Particularly, it is a regression model to predict X(*, tₙ) with X(*, t₁: tₙ₋₁):

X(*,tₙ)=Σᵣ₌₁ⁿ⁻¹AᵣX(*,tᵣ)+ε(*,tₙ) EQ. 1

where ε(*, tn)∈ [symbol] ^{m×1} is a white Gaussian random vector at time tₙ, n−1 is the time order (involved time lags), and Aᵣ is the causal graph for each time lag r. Time series X(i, *) is called a Granger cause of time series X(j, *) if at least one of the elements Aᵣ(i, j) for r=1, 2, . . . , n−1 is significantly larger than zero (in absolute value).

However, Equation (1) is purely linear and does not capture any nonlinear causal relationships. The TCCL model described herein rectifies that Comparatively, our TCCL model does not involve any kernel assumption, and targets on discovering a more general and complex causal relationship for multivariate and nonlinear time series.

In this disclosure, given a collection of labeled time series χ={(X₁, Y₁), (X₂, Y₂), . . . , (X_{N}, Y_{N})} as training set, the TCCL model classifies the input time series and learns the causal graph Aₖ of each class (k=1, 2, . . . , K). Using the above time series, the goal is to predict X(*, tₙ) with X(*, t₁: tₙ₋₁).

In the exemplary embodiment, the TCCL model is trained using labeled time series of data, where the time series of data have labels that precede events in the time series of data. The TCCL model includes multi-layered modified Gated Recurrent Units (GRUs) which are used to analyze the time series of data. Then that analysis is used to train causal graphs, which analyze the time series data to determine correlations between variables and the start of events. During training, the TCCL model generates a plurality of classes of events. After the model is trained, the model receives real-time data from one or more sensors, or other time series data, to analyze. The trained model uses the modified GRUs and causal graphs to determine if an event is occurring and what class of event may be occurring. The model compares predicted results of the various classes to the actual results to determine which class label to use on an event or a soon to be occurring event. In some embodiments, the label triggers a warning that allows one or more systems or users to prevent the event.

For the purposes of this discussion, classes refer to categories of events. For example in full flight data, healthy/normal data is treated as the majority class or the first class. In addition, there are two unhealthy classes from abnormal running patterns. One is with large difference between left and right duct pressure, and the other is with large difference between left and right exit temperature.

After training on these data, the causal graph of the first unhealthy class shows broken causality/interrelationship between left and right duct pressure (compared against the causal graph from healthy class), while the causal graph of the second shows broken interrelationship between left and right exit temperature (compared against the causal graph from healthy class). The interrelationships determined from these causal graphs allow the user to determine the cause of these events. It also allows the user to take corrective action, potentially in real-time.

Described herein are computer systems such as the TCCL computer devices and related computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application-specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer-readable medium. In an example embodiment, the system is executed on a single computer system, without requiring a connection to a server computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The systems and processes are not limited to the specific embodiments described herein. In addition, components of each system and each process can be practiced independent and separate from other components and processes described herein. Each component and process also can be used in combination with other assembly packages and processes.

FIG. 1 illustrates a block diagram of a time series classification and causal graph learning (TCCL) model 100 in accordance with one embodiment of the present disclosure. In the exemplary embodiment, the TCCL model 100 is trained using regression setting to learn time series classification and causal graph for each class. The goal of the TCCL model 100 is to predict X(*, tₙ) with X(*, t₁: tₙ₋₁).

In the exemplary embodiment, the TCCl model 100 includes four modules 102-108. A first module 102 analyzes the temporal non-linearity with recurrent learning units. In the exemplary embodiment, the first module 102 analyzes the temporal nonlinearity using multi-layers modified Gated Recurrent Units (GRUs) 112. A second module 104 discovers the underlying causal graph for each class. A third module 106 prospects intervariable nonlinearity between the time series. A fourth module 108 is the prediction module. As is described more fully below, the first module 102 is applied across different classes 114, but each class 114 has its own separate second module 104, third module 106, and fourth module 108. For example, the primary class may be a normal operation class, while two other classes may be when a portion of the device if malfunctioning, such as a vibration error or a large difference between left and right duct pressure.

In the exemplary embodiment, the TCCL model 100 is trained to recognize and label events as well as to generate causal graphs for the labeled events based on multivariate time series input 110. Then the TCCL model 100 receives real-time sensor data 110 and analyzes the real-time sensor data 110 to detect and label events. In the exemplary embodiment, the system responds to those events to take mitigating measures.

In the exemplary embodiment, the back-propagation update during training described herein is controlled by the corresponding class label. During the testing/validation stage, the label 116 of the input time series 110 is determined by the minimum regression residual.

In the exemplary embodiment, the first module 102 includes modified Gated Recurrent Units (GRUs) 112 as shown in FIG. 2. Referring to FIG. 2, each GRU 200 includes the following formula

Z=sigmoid(X(*,tⱼ)B_{z}+Gⱼ¹U_{Z}+b_{Z} EQ. 2

F=sigmoid(X(*,tⱼ)B_{F}+Gⱼ¹U_{F}+b_{F} EQ. 3

Gⱼ¹=(1−Z)^{∘}Gⱼ¹+Z^{∘} tanh(X(*,tⱼ)B_{G}+(F^{∘}Gⱼ¹)U_{G}+b_{G}) EQ. 4

where X(*, tⱼ)∈ [symbol] ^{m×1} is the values of all the m variables at time tⱼ, Gⱼ¹∈ [symbol] ^{m×p} is the current state, B_{Z}/B_{F}/B_{G} ∈ [symbol] ^{1×p} and U_{Z}/U_{F}/U_{G} ∈ [symbol] ^{p×p} are the weight matrices, and b_{Z}/b_{F}/b_{G} are bias vectors. Z is called update gate vector and F is called reset gate vector. With the multi-layer GRU 112, the q-th layer input is Gⱼ^{q}, which is from the (q−1)-th layer output, with q=1, 2, . . . , Q where Q is the total number of GRU cells. Each G^{q}ⱼ₊₁ represents certain level of temporal nonlinearity in X(*, t₁: tⱼ). Given Q is the total number of residual blocks, G^{1:Q}ⱼ₊₁∈ [symbol] ^{m×pQ} can approximate the nonlinear transformation involving X(*, t₁: tⱼ) on univariate level. The output of all the GRU layers 112 in the first module 102 are then the input into the next module 104, and denoted as \tilde{G}∈ [symbol] ^{pQ×m} which equals to (G^{1:Q}ⱼ₊₁)^{T}.

FIG. 2 illustrates a block diagram of an exemplary gated recurrent unit 200 used with the TCCL model 100 (shown in FIG. 1). In the exemplary embodiment, the GRU 200 is modified to be different from traditional GRUs. Tradition GRUs project data from input dimensions m to feature embedding space. However, the modified GRU 200, present herein, projects data to temporal embedding space. More specifically, a traditional GRU projects X(*, tⱼ)∈ [symbol] ^{m×1} to G¹ⱼ₊₁∈ [symbol] ^{p×1}. In contrast, the modified GRU 200 projects it to G¹ⱼ₊₁∈ [symbol] ^{m×p}. In other words, the first module 102 focuses on learning the temporal nonlinearity on univariate level, without rolling information between time series. The reason is that such rolling should only involve the factor variables of each time series, which should be controlled by the causal graph in the second module 104. If the causal graph is involved too early, then the causal learning will not be effective.

In the exemplary embodiment, the output from all layers of GRUs 112 are fed as inputs into the second module 104. This allows the model 100 to examine the effect of each level of temporal nonlinearity to determine their effect to the underlying causal graph.

In some embodiments, the modified GRU 112 has an adaptive initial state 118 (shown as G1 118 in in FIG. 1). To prevent initializing the hidden state as zeros, which can cause large loss terms for the first few time steps, which may cause the model 100 to focuses less on the actual sequence. Accordingly, in these embodiments, the initial state 118 is trained as a variable with additional noise perturbation to improve performance of the model 100.

In the exemplary embodiment, the second module 104 is configured to learn the causal graphs of all the known classes 114. From the output \tilde{G}∈ [symbol] ^{pQ×m} of the first module 102, the model 100 selects those variables that contribute to predict X(*, tₙ). In the exemplary embodiment, this selection can be controlled by a learned causal graph. Since each class has its own causal graph, given the learned causal graph A^{(k)}∈ [symbol] ^{m×m} of the k-th class, this can be done by

\tilde{G}^{(k)}(*,i)=\tilde{G}A^{(k)}(*,i), i=1,2, . . . ,n EQ. 5

where A^{(k)}(*, i) is the i-th column in A^{(k)}. As shown in the matrix multiplication, A^{(k)}(*, i) has larger values on the elements of which the corresponding time series have higher influence on the i-th time series in terms of regression. That is, for the i-th variable in the time series, the large elements in the i-th column indicates the causes of i-th variable, and the large elements in the i-th row represents the variables influenced by i-th variable. Therefore, the output of the second module 104 is the features learned on the intervariate level for each time series for each class 114.

In the exemplary embodiment, the third module 106 determines the nonlinearity among the time series. The input is (\tilde{G}^{(k)})^{T}∈ [symbol] ^{m×pQ}, k=1, 2, . . . K from the second module 104. The third module 106 consists of a series of fully connected layers by setting H₀^{(k)}=(\tilde{G}^{(k)})^{T}, the j-th layer output is then defined as:

Hⱼ^{(k)}=σ(Hⱼ₋₁^{(k)}Wⱼ^{(k)}+bⱼ^{(k)}), j=1,2, . . . ,D EQ. 6

where Hⱼ₋₁^{(k)}∈ [symbol] ^{m×dj-1} is the output of layer j−1, Wⱼ^{(k)}∈ [symbol] ^{dj-1×dj} is a weight matrix, and bⱼ^{(k)} is a bias vector. The activation function is tanh. The final output of the third module 106 is H_{D}^{(k)}∈ [symbol] ^{m×dD} where D is the total number of layers in the third module 106. Accordingly, \tilde{G}^{(k)} (i, *) contains the linear combinations of all the temporal nonlinearity from the factor variables of time series X(i, *) according to causality of the k-th class.

The fourth module 108 is designed for time series prediction. The i-th row of H_{D}^{(k)} contains all of the contributing nonlinear forms from the causes of X(i, *) to predict X(i, tₙ) using the learned pattern of the k-th class, where i=1, 2, m. For each k=1, 2, . . . , K, the target \hat{X}^{(k)}(i, tₙ)∈ [symbol] ^{m×1} is predicted using H_{D}^{(k)} from the third module 106. Specifically, the regression is performed by a row-wise dot product:

\hat{X}^{(k)}(i,tₙ)=H_{D}^{(k)}(i*)^{∘}(R^{(k)}(i,*) EQ. 7

where i=1, . . . , m and k=1, . . . , K. Accordingly, the model 100 determines the optimal combination in H_{D}^{(k)} to approach \hat{X}^{(k)}(i, tₙ) by row.

In the exemplary embodiment, the loss is mainly computed by mean squared error (MSE) between the predicted values and the actual values weighted by ground-truth labels, with regularization on the learned causal graph A^{(k)}:

$$\begin{matrix}{L}_{\hat{N}} = \frac{1}{Nm} {\sum }_{t = 1}^{N} {\sum }_{i = 1}^{m} {( k )}^{} {( {X}_{t} ( i , {t}_{n} ) - {\hat{X}}_{t}^{( k )} ( i , {t}_{n} ) )}^{2} + λ {\sum }_{k = 1}^{K} {‖ {A}^{( k )} ‖}_{2} + β {\sum }_{( {k}_{1} , {k}_{1} ) ϵ [ 1 , K ] , k 1 \neq k 2} exp ( - {‖ {A}^{( {k}_{1} )} - {A}^{( {k}_{2} )} ‖}_{2} ) & EQ . 8 \\ where & \\ {( k )}^{} = \{ \begin{matrix}1 , & if {X}_{t} belongs to the k - th class \\ 0 , & otherwise\end{matrix} & \end{matrix}$$

where N is the number of training time series, m is the number of input variables and λ∈ [symbol] is the penalty parameter. The model 100 adds the first [symbol] ₂ regularization term to avoid over-fitting on the causal graph learning. The second term is to enforce the learned causal graphs to be different between classes. During run time, the model 100 assigns the class label according to the smallest residual between Xₜ(i, tₙ) and \hat{X}^{(k)}(i,tₙ), where k=1, 2, . . . , K.

FIG. 3 is a flowchart illustrating an example process 300 for training the TCCL model 100 (shown in FIG. 1). Process 300 may be implemented by a computing device, for example the classifying server 510 (shown in FIG. 5).

In the exemplary embodiment, the classifying server 510 receives 305 a labeled time series of data. In the exemplary embodiment, the labeled time series of data is multivariate and includes a plurality of points in time. The time series also includes at least one label, where the label is positioned a predetermined period of time before an event in the time series of data. In some embodiments, the classifying server 510 inserts the label based on user input.

In the exemplary embodiment, the classifying server 510 analyzes 310 the labeled time series of data using a plurality of GRU cells, such as the GRU 112 (shown in FIG. 1) and GRU 200 (shown in FIG. 2).

In the exemplary embodiment, the classifying server 510 generates 315 a causal graph based on the analysis, wherein the causal graph includes the plurality of variables included in the labeled time series of data. In the exemplary embodiment, the classifying server 510 generates 315 the causal graph using the outputs of all of the GRU layers used in Step 310.

In the exemplary embodiment, the classifying server 510 generates 320 a plurality of linear combinations of temporal non-linearity based on the causal graph and the labeled time series of data. In the exemplary embodiment, the classifying server 510 calculates 325 a predicted value for one or more variables of the labeled time series of data based on the plurality of linear combinations.

In the exemplary embodiment, the classifying server 510 compares 330 the predicted value(s) to the observed value(s) from the labeled time series of data. The classifying server 510 adjusts 335 the model 100 based on the comparison. In some embodiments, the classifying server 510 adjusts 335 one or more weights associated with the GRUs 200. In other embodiments, the classifying server 510 adds a class to the model 100, where the class quantifies a type of event where the event is contained in the labeled time series of data. In other embodiments, the classifying server 510 updates one or more weights associated with one or more existing classes.

In the exemplary embodiment, process 300 is repeated multiple times to train the model 100. In this embodiment, process 300 may receive 305 multiple labeled time series of data. In some embodiments, process 300 receives 305 the labeled time series of data serially at the process 300 continues iterations.

FIG. 4 is a flowchart illustrating an example process 400 for monitoring data using the TCCL model 100 (shown in FIG. 1). Process 400 may be implemented by a computing device, for example the classifying server 510 (shown in FIG. 5).

In the exemplary embodiment, the classifying server 510 receives 405 an unlabeled time series of data including a plurality of points in time. In some embodiments, the unlabeled time series of data is provided in real-time by one or more sensors 505 (shown in FIG. 5).

In the exemplary embodiment, the classifying server 510 analyzes 410 the time series of data using a plurality of GRU cells, such as the GRU 112 (shown in FIG. 1) and GRU 200 (shown in FIG. 2).

In the exemplary embodiment, the classifying server 510 compares 415 the results of the analysis step 410 to the plurality of causal graphs, each causal graph associated with one of a plurality of classes of events. In the exemplary embodiment, the classifying server 510 uses the outputs of all of the GRU layers used in Step 410.

In the exemplary embodiment, for each class of event the classifying server 510 calculates 420 a predicted value for one or more variables of the time series of data based on the plurality of linear combinations. In other words, the classifying server 510 analyzes each of the classes to determine which class applies to the current data. For example, one class may be normal operation and the other classes may signify different error conditions. By determining which class the current operation of the device applies to, the user may be quickly alerted to changes.

In the exemplary embodiment, the classifying server 510 compares 425 the predicted values to the observed values from the time series of data. Then the classifying server 510 determines which of the sets of predicted values and the observed values have the least difference. This may accomplished by comparing individual values or by analyzing means squared error or another analysis method. The classifying server 510 determines which of the classes is associated with the predicted values with the least difference or that are the closest to the actual observed values. Then the classifying server 510 assigns 430 the label corresponding to that class to that time series of data or portion of time series of data.

In some embodiments, the classifying server 510 adjusts 435 the performance of a device associated with the time series of data based on the label. For example, the device may be a turbine and the event may be a vibration event. In these embodiments, the classifying server 510 may instruct the turbine to decrease rotational speed to counteract the vibration event.

In the exemplary embodiment, the classifying server 510 continues process 400 for each point of data in the time series of data. In the case of a continuous feed from one or more sensors, classifying server 510 continually updates to determine what the current class and corresponding label is for the current data.

FIG. 5 is a simplified block diagram of an example system 500 for executing the TCCL model 100 (shown in FIG. 1) during the processes 300 and 400 (shown in FIGS. 3 and 4). In the example embodiment, system 500 is used for analyzing time series data to detect events before or while they are occurring. In addition, system 500 is a real-time data analyzing and classifying computer system that includes a classifying computer device 510 (also known as a classifying server) configured to analyze for and label events.

Sensor 505 observes a device or system over time. More specifically, sensor 505 measures a measured attribute of the observed device or system and is in communication with a classifying computer device 510. Sensor 505 connects to classifying computer device 510 through various wired or wireless interfaces including without limitation a network, such as a local area network (LAN) or a wide area network (WAN), dial-in-connections, cable modems, Internet connection, wireless, and special high-speed Integrated Services Digital Network (ISDN) lines. Sensor 505 receives data about conditions of an observed device or system and reports those conditions to classifying computer device 510. In other embodiments, sensors 505 are in communication with one or more client systems 525 and the client systems 525 route the sensor data to the classifying computer device 510. In some embodiments, the sensor 605 measures one or more of temperature, vibration, revolutions, position (relative or absolute), angular rotation, humidity, light level, weather conditions, and other environmental conditions.

As described below in more detail, the classifying server 510 is programmed to analyze data for potential events to allow the system 500 to respond to the event quickly. The classifying server 510 is programmed to a) receive an unlabeled time series of data; b) analyze the unlabeled time series of data with a plurality of GRU cells; c) compare the analyzed data to the plurality of causal graphs; d) for each class of event, calculate a predicted value for one or more variables; e) compare the predicted values to the observed value; f) assign a label to the time series of data based on the comparison; and (g) adjust performance of a device associated with the time series of data based on the label.

In the example embodiment, client systems 525 are computers that include a web browser or a software application, which enables client systems 525 to communicate with classifying server 510 using the Internet, a local area network (LAN), or a wide area network (WAN). In some embodiments, client systems 525 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Client systems 525 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment.

A database server 515 is communicatively coupled to a database 520 that stores data. In one embodiment, database 520 is a database that includes weights, labels, and causal graphs from training the model 100. In some embodiments, database 520 is stored remotely from classifying server 510. In some embodiments, database 520 is decentralized. In the example embodiment, a person can access database 520 via client systems 525 by logging onto classifying server 510.

FIG. 6 illustrates an example configuration of client system 525 shown in FIG. 5, in accordance with one embodiment of the present disclosure. User computer device 602 is operated by a user 601. User computer device 602 may include, but is not limited to, sensors 505 and client systems 525 (both shown in FIG. 5). User computer device 602 includes a processor 605 for executing instructions. In some embodiments, executable instructions are stored in a memory area 610. Processor 605 may include one or more processing units (e.g., in a multi-core configuration). Memory area 610 is any device allowing information such as executable instructions and/or transaction data to be stored and retrieved. Memory area 610 may include one or more computer-readable media.

User computer device 602 also includes at least one media output component 615 for presenting information to user 601. Media output component 615 is any component capable of conveying information to user 601. In some embodiments, media output component 615 includes an output adapter (not shown) such as a video adapter and/or an audio adapter. An output adapter is operatively coupled to processor 605 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 615 is configured to present a graphical user interface (e.g., a web browser and/or a client application) to user 601. A graphical user interface may include, for example, an interface for viewing the results of the analysis of one or more subject systems. In some embodiments, user computer device 602 includes an input device 620 for receiving input from user 601. User 601 may use input device 620 to, without limitation, select a computer system to view the analysis of Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 602 may also include a communication interface 625, communicatively coupled to a remote device such as classifying server 510 (shown in FIG. 5). Communication interface 625 may include, for example, a wired or wireless network adapter and/or a wireless data transceiver for use with a mobile telecommunications network.

Stored in memory area 610 are, for example, computer-readable instructions for providing a user interface to user 601 via media output component 615 and, optionally, receiving and processing input from input device 620. A user interface may include, among other possibilities, a web browser and/or a client application. Web browsers enable users, such as user 601, to display and interact with media and other information typically embedded on a web page or a website from classifying server 510. A client application allows user 601 to interact with, for example, classifying server 510. For example, instructions may be stored by a cloud service, and the output of the execution of the instructions sent to the media output component 615.

Processor 605 executes computer-executable instructions for implementing aspects of the disclosure. In some embodiments, the processor 605 is transformed into a special purpose microprocessor by executing computer-executable instructions or by otherwise being programmed.

FIG. 7 illustrates an example configuration of the server system 510 shown in FIG. 5, in accordance with one embodiment of the present disclosure. Server computer device 701 may include, but is not limited to, database server 515 and classifying server 510 (both shown in FIG. 5). Server computer device 701 also includes a processor 705 for executing instructions. Instructions may be stored in a memory area 710. Processor 705 may include one or more processing units (e.g., in a multi-core configuration).

Processor 705 is operatively coupled to a communication interface 715 such that server computer device 701 is capable of communicating with a remote device such as another server computer device 701, another classifying server 510, or client system 525 (shown in FIG. 5). For example, communication interface 715 may receive requests from client system 525 via the Internet, as illustrated in FIG. 5.

Processor 705 may also be operatively coupled to a storage device 734. Storage device 734 is any computer-operated hardware suitable for storing and/or retrieving data, such as, but not limited to, data associated with database 520 (shown in FIG. 5). In some embodiments, storage device 734 is integrated in server computer device 701. For example, server computer device 701 may include one or more hard disk drives as storage device 734. In other embodiments, storage device 734 is external to server computer device 701 and may be accessed by a plurality of server computer devices 701. For example, storage device 734 may include a storage area network (SAN), a network attached storage (NAS) system, and/or multiple storage units such as hard disks and/or solid state disks in a redundant array of inexpensive disks (RAID) configuration.

In some embodiments, processor 705 is operatively coupled to storage device 734 via a storage interface 720. Storage interface 720 is any component capable of providing processor 705 with access to storage device 734. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 734.

Processor 05 executes computer-executable instructions for implementing aspects of the disclosure. In some embodiments, the processor 705 is transformed into a special purpose microprocessor by executing computer-executable instructions or by otherwise being programmed. For example, the processor 705 is programmed with instructions such as illustrated in FIGS. 3 and 4.

At least one of the technical solutions provided by this system to address technical problems may include: (i) improved analysis of live sensor feeds; (ii) increased accuracy in determining the underlying cause of events; (iii) improved speed of training models; (iv) more accurate time series classification; and (v) reducing errors due to noise in a dataset or limited amounts of data.

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics and information, historical estimates, and/or actual repair costs. The machine learning programs may utilize deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing—either individually or in combination. The machine learning programs may also include natural language processing, semantic analysis, automatic reasoning, and/or machine learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about infrastructures and users associated with a building to detect events and correlations between detected events to identify trends.

Based upon these analyses, the processing element may learn how to identify characteristics and patterns that may then be applied to analyzing image data, model data, and/or other data. For example, the processing element may learn, with the user's permission or affirmative consent, to identify the type of building events that occurred based upon collected images of building. The processing element may also learn how to identify building trends that may not be readily apparent based upon collected sensor data.

The methods and system described herein may be implemented using computer programming or engineering techniques including computer software, firmware, hardware, or any combination or subset. As disclosed above, at least one technical problem with prior systems is that there is a need for systems for a cost-effective and reliable manner for analyzing data to predict events. The system and methods described herein address that technical problem. Additionally, at least one of the technical solutions provided by this system to overcome technical problems may include: (i) improved analysis of live sensor feeds; (ii) increased accuracy in determining the underlying cause of events; (iii) improved speed of training models; (iv) more accurate time series classification; and (v) reduced errors due to noise in a dataset or limited amounts of data.

The methods and systems described herein may be implemented using computer programming or engineering techniques including computer software, firmware, hardware, or any combination or subset thereof, wherein the technical effects may be achieved by performing at least one of the following steps: (a) receive an unlabeled time series of data; b) analyze the unlabeled time series of data with a plurality of GRU cells; c) compare the analyzed data to the plurality of causal graphs; d) for each class of event, calculate a predicted value for one or more variables; e) compare the predicted values to the observed value; f) assign a label to the time series of data based on the comparison; and (g) adjust performance of a device associated with the time series of data based on the label.

The technical effects may also be achieved by performing at least one of the following steps: (a) receive a labeled time series of data; (b) analyze the labeled time series of data with a plurality of GRU cells; (c) generate a causal graph of an event based on the analysis; (d) generate a plurality of linear combinations based on the causal graph; (e) calculate a predicted value for one or more variables; (f) compare the predicted value to the observed value; and (g) adjust the model based on the comparison.

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein may include additional, less, or alternate functionality, including that discussed elsewhere herein. The computer systems discussed herein may include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose various implementations, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
a computing device comprising at least one processor in communication with at least one memory device, wherein the at least one processor is programmed to:
execute a model for analyzing a time series of data;
receive a labeled time series of data including a plurality of variables at a plurality of points in time;
analyze the labeled time series of data;
generate a causal graph of an event based on the analysis;
calculate a predicted value for one or more variables of the plurality of variables at a specific point in time;
compare the predicted value to an observed value for the one or more variables; and
adjust the model based on the comparison.

2. The system of claim 1, wherein the labeled time series of data includes at least one label and at least one event, and wherein the at least one label precedes the at least one event.

3. The system of claim 1, wherein the at least one processor is further programmed to generate a class for the label and the corresponding event.

4. The system of claim 1, wherein the at least one processor is further programmed to analyze the labeled time series of data with a plurality of Gated Recurrent Units (GRUs).

5. The system of claim 4, wherein the plurality of GRUs are modified to project data into a temporal embedding space.

6. The system of claim 4, wherein the plurality of GRUs include a plurality of layers of GRUs.

7. The system of claim 6, wherein the at least one processor is further programmed to utilize results from each layer of GRU to generate the causal graph.

8. The system of claim 1, wherein the at least one processor is further programmed to generate a plurality of linear combinations based on the causal graph and the labeled time series of data.

9. The system of claim 1, wherein the model is adjusted to detect the event based on the time series of data.

10. The system of claim 1, wherein the at least one processor is further programmed to:
receive a plurality of different labeled time series of data; and
adjust the model based on the analysis of each of the plurality of different labeled time series of data.

11. A system comprising:
a computing device comprising at least one processor in communication with at least one memory device, wherein the at least one processor is programmed to:
execute a model for analyzing a time series of data, wherein the model includes a plurality of classes;
receive an unlabeled time series of data including a plurality of variables at a plurality of points in time;
analyze the unlabeled time series of data;
compare the analyzed data to the plurality of classes;
for each class of the plurality of classes, calculate a predicted value for one or more variables of the plurality of variables at a specific point in time;
compare the plurality of predicted values to an observed value for the one or more variables; and
assign a label to the time series of data based on the comparison.

12. The system of claim 11, wherein the unlabeled time series of data is based on sensor data of a device.

13. The system of claim 11, wherein the at least one processor is further programmed to adjust performance of a device associated with the time series of data based on the label.

14. The system of claim 11, wherein the at least one processor is further programmed to analyze the unlabeled time series of data with a plurality of Gated Recurrent Units (GRUs).

15. The system of claim 14, wherein the plurality of GRUs are modified to project data into temporal embedding space.

16. The system of claim 14, wherein the plurality of GRUs include a plurality of layers of GRUs.

17. A method for detecting an event, the method implemented by a computing device including at least one processor in communication with at least one memory device, the method comprising:
executing a model for analyzing a time series of data, wherein the model includes a plurality of classes;
receiving an unlabeled time series of data including a plurality of variables at a plurality of points in time;
analyzing the unlabeled time series of data;
comparing the analyzed data to the plurality of classes;
for each class, calculating a predicted value for one or more variables of the plurality of variables at a specific point in time;
comparing the predicted value to an observed value for the one or more variables; and
assigning a label to the time series of data based on the comparison.

18. The method of claim 17, wherein the unlabeled time series of data is based on sensor data of a device, and wherein the method further comprises adjusting performance of a device associated with the time series of data based on the label.

19. The method of claim 17 further comprising analyzing the unlabeled time series of data with a plurality of Gated Recurrent Units (GRUs), wherein the plurality of GRUs are modified to project data into temporal embedding space, and wherein the plurality of GRUs include a plurality of layers of GRUs.

20. The method of claim 17 further comprising calculating the predicted value for each class of the plurality of classes, wherein each class is associated with a type of event and wherein the label is associated with the type of event detected.
